(19) United States
(12) Patent Application Publication
(10) Pub. No.: US 2013/0293671 A1
(43) Pub. Date: Nov. 7, 2013

(54) SYSTEMS AND METHODS FOR STITCHING AND SHARING PANORAMAS

(71) Applicant: TOURWRIST, INC., San Francisco, CA (US)

(72) Inventors: Alexander I. Gorstan, Owings Mills, MD (US); Charles Robert Armstrong, San Francisco, CA (US); Kang S. Lim, San Ramon, CA (US)

(73) Assignee: TOURWRIST, INC., San Francisco, CA (US)

(21) Appl. No.: 13/797,978

(22) Filed: Mar. 12, 2013

Related U.S. Application Data
(60) Provisional application No. 61/641,144, filed on May 1, 2012.

(51) Int. Cl. H04N 5/232

(52) U.S. Cl. CPC H04N 5/23238
USPC 348/36

(57) ABSTRACT

The present invention relates to systems and methods for stitching and sharing panoramas. In one embodiment, a computerized mobile device downsizes a plurality of captured images. The mobile device transmits the downsized images to a server with a panoramic stitcher. The server analyzes the downsized images and generates stitching parameters for the mobile device. The mobile device uses the stitching parameters to stitch the plurality of captured images into a panorama which can be shared with one or more recipients.

### CROSS REFERENCE TO RELATED APPLICATION

This non-provisional application claims the benefit of provisional application No. 61/641,144 filed on May 1, 2012, entitled “Systems and Methods for Stitching and Sharing Panoramas”, which application is incorporated herein in its entirety by this reference.

### BACKGROUND

The present invention relates to systems and methods for panoramas. More particularly, the present invention relates to efficient stitching and sharing of panoramic images for mobile devices.

With the increasing wideband capabilities of wide area networks (e.g., 4G) and proliferation of mobiles devices, such as smart phones, with abundant memory and processing power, users are now able to quickly capture and share large media file seamlessly with friends, family and business associates.

However, many broadband wireless service plans charge an excess usage fee for users who exceed their monthly maximum on total amount of data transmitted and received, in order to discourage extreme high usage users from hogging and slowing their cellular networks down. Hence, users are incentivized to avoid unnecessary transmission or receipts of large media files. Unfortunately, transmitting groups of high definition images to be stitched into panoramas by remote servers quickly depletes users' monthly data limit.

It is therefore apparent that an urgent need exists for efficiently stitching panoramas without having to install a full-function stitcher on a mobile device and then be able to share the resulting panoramas, without utilizing excessive transmission bandwidth.

### SUMMARY

To achieve the foregoing and in accordance with the present invention, systems and methods sharing of stitched panoramas is provided. In particular, the systems and methods for efficiently stitching panoramas using stitching parameters generated from one or more downsized images.

In one embodiment, a computerized mobile device is configured to efficiently stitch a plurality of images into a panorama for sharing with one or more recipients. The mobile device downsizes one or more of a plurality of captured images. The mobile device transmits the downsized image(s) to a server that includes a panoramic stitcher. The server analyzes the downsized image(s) and generates stitching parameters for the mobile device. Exemplary stitching parameters include order of images, coordinates of stitching borders, image orientation, zoom corrections, contrast corrections and relative chrominance corrections. The mobile device uses the stitching parameters to stitch the plurality of captured images into a panorama which can be shared with one or more recipients.

Downsizing of the image files can be accomplished using one or more of these exemplary methods, including substantially downsampling and generating a lower-resolution downsized image. Downsizing can also be accomplished by vectorizing images. Image files can also be downsized by substantially reducing chromatic data, e.g., by generating a black and white image from a color image. Since stitching generally involves the peripheries of the images, downsizing can also be accomplished by substantially masking a central portion of the captured images.

In some embodiments, the mobile device sends the panorama together with associated EXIF metadata to a recipient, enabling the recipient to, for example, geographically identify the panorama from the attached latitudinal and longitudinal data. It is also possible to attach EXIF metadata that is representative of at least two of the plurality of captured images.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an exemplary flow diagram illustrating sharing of panoramas from a mobile device in accordance with one embodiment of the present invention;

FIG. 2 is a more detailed flow diagram illustrating stitching of images into a panorama by a server for the mobile device described in FIG. 1;

FIG. 3 is a more detailed flow diagram illustrating the generation of stitching parameters by a server from one or more downsized image provided by the mobile device described in FIG. 1;

FIG. 4 is an exemplary flow diagram illustrating the capture of images by the mobile device described in FIG. 1;

FIG. 5 is a screenshot illustrating exemplary media capture options for the mobile device described in FIG. 1; and

FIG. 6 is a screenshot illustrating the sharing of exemplary media for the mobile device described in FIG. 1.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

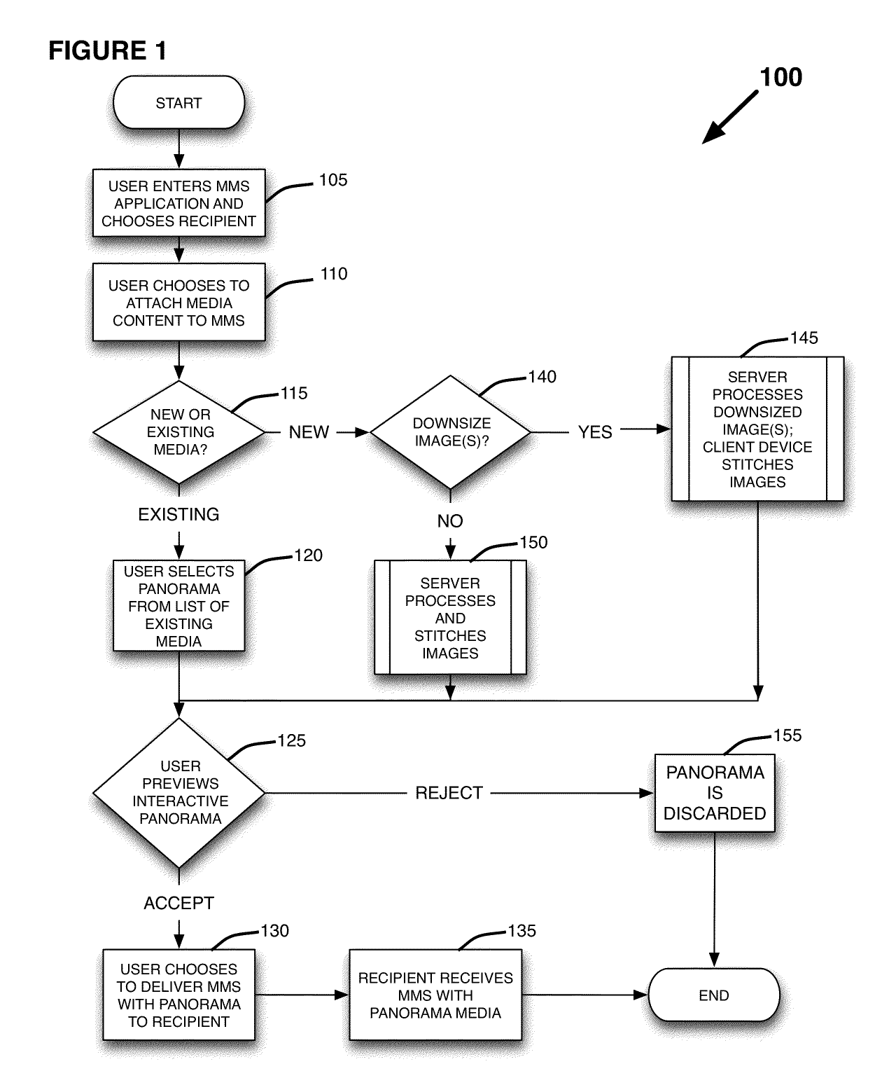

The present invention relates to systems and methods for distributed stitching and sharing panoramic images. Note that the term “mobile device” is intended to include all portable electronic devices including cellular phones, computerized tablets, cameras, and hand-held gaming devices. To facilitate discussion, FIG. 1 is an exemplary flow diagram 100 illustrating how panoramic images may be stitched from captured images and then shared with other viewers via one embodiment of a mobile device.

With the proliferation of a wide variety of mobile devices and choice of wideband service providers, Multi-media Messaging Service (“MMS”) provide users of mobile devices with a convenient way of sending text messages together with a wide variety of multi-media attachments, including photos, video clips, panoramas and audio files.

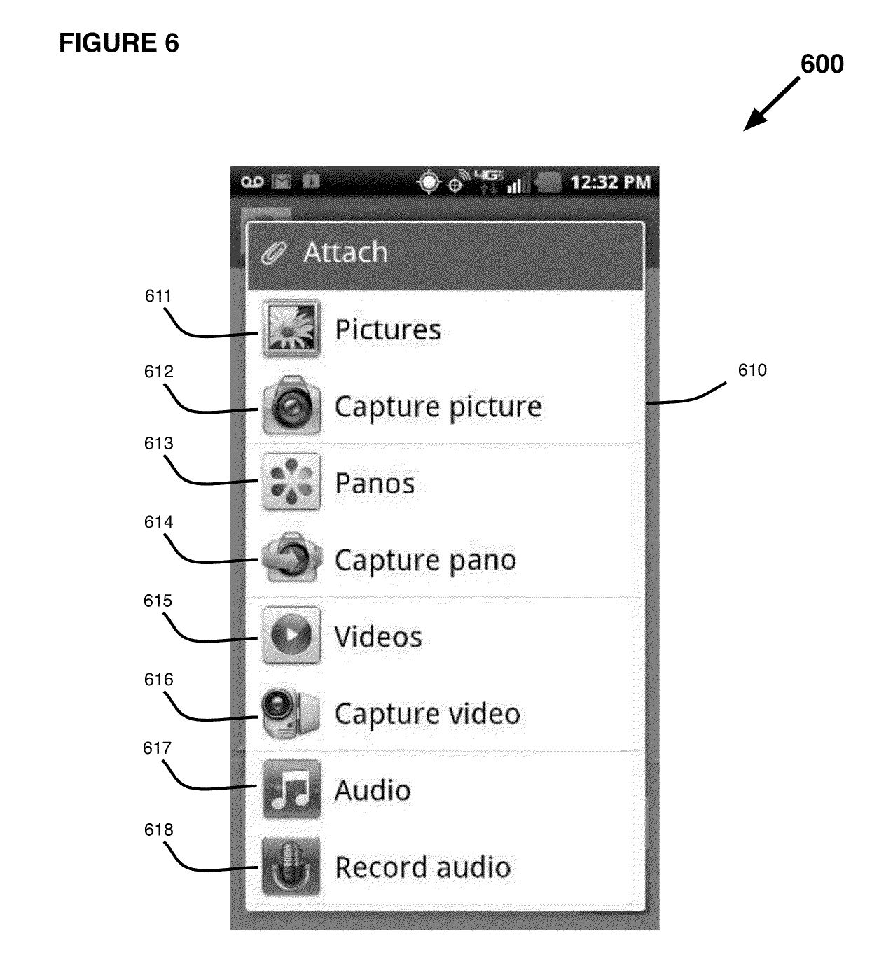

As shown in the flow diagram 100 of FIG. 1 and the screenshot 600 of FIG. 6, a user begins by activating an MMS application on a mobile device and selecting one or more recipients (step 105). In step 110, the mobile device provides a pop-up window 610 enabling the user to attach one or more of a variety of media files, such as a panorama, also commonly known as a panoramic image. If the user selects an existing media, such as an existing panorama (icon 613), then the user may select and/or preview one or more panoramas from a library of existing panoramas stored in the user's mobile device (see steps 115, 120, 125).

Conversely if the user elects to attach a new panorama by selecting icon 614 (step 115), then at least two options are provided by the mobile device. In this embodiment, after capturing a set of images, the user can elect to send the captured images to be stitched into a panorama by a remote server (steps 140, 150), or elect to downsize one or more of the captured images locally before the downsized image(s) are pre-processed by a remote server and then complete the stitching using the mobile device (steps 140, 145).

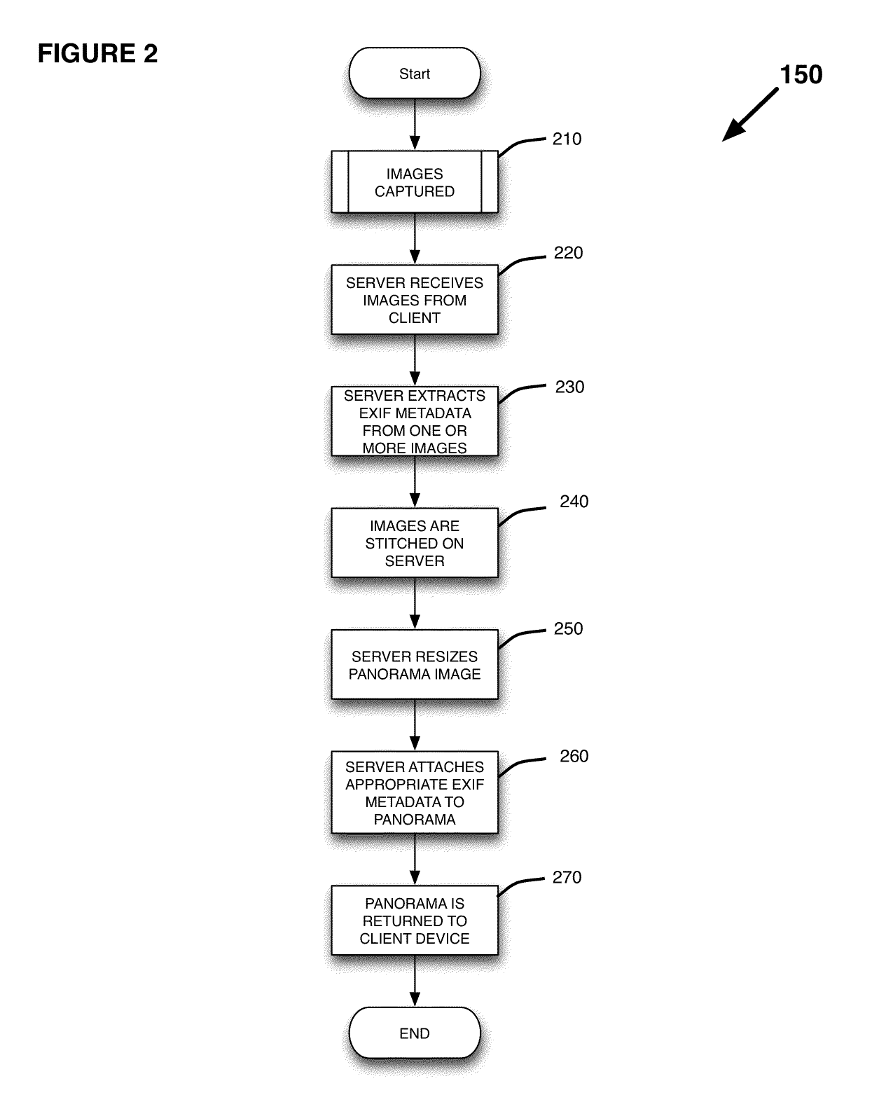

FIG. 2 is a more detailed flow diagram 150 illustrating stitching of the images captured by the mobile device into a panorama by the remote server. After capturing the images (step 210), the images are transmitted by the mobile device to the remote server. Upon receipt of the captured images (step 220), the server extracts EXchangeable Image File-format (“EXIF”) metadata from one or more of the captured images, e.g., using the EXIF of the earliest, middle, or last image from the set of captured images, or averaging the EXIF timestamps from multiple images (step 230).

Using stitching techniques known to one skilled in the art, the server stitches the captured images into a panorama (step 240). Commercial stitching software includes Photoshop Elements available from Adobe Corporation, of San Jose, Calif., Microsoft Digital Image Suite or PhotoSynth available from Microsoft Corporation of Redmond, Wash., and PanoStitcher available from Pixtra Corporation, incorporated in Delaware.

In some embodiments, the server also resizes the panorama and/or attaches EXIF metadata to the panorama (steps 250 and 260). It is also possible for the server to comingle and recompile EXIF metadata from two or more images, e.g., by averaging timestamps, thereby creating a more representative EXIF metadata for the panorama. The stitched panorama with optional metadata attached is then transmitted to the mobile device (step 270).

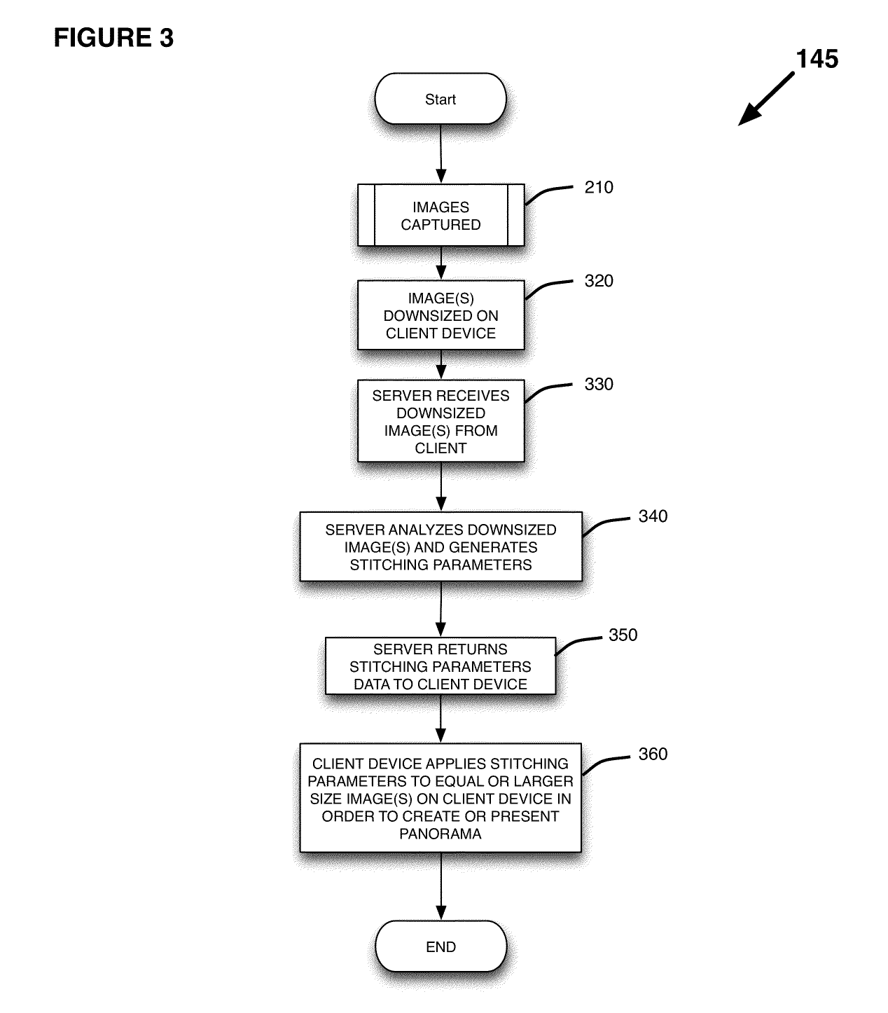

FIG. 3 is a more detailed flow diagram 145 illustrating the downsizing of one or more captured images for pre-processed by the remote server, before stitching the panorama locally using the mobile device. After capturing the images (step 210), one or more of the captured images can be downsized by the mobile device before transmission to the remote server (step 320). Upon receipt of the downsized image(s) (step 330), a panoramic stitcher of the server analyzes the downsized image(s) together with any captured image(s) provided by the mobile device, and generates stitching parameters such as order of images, coordinates of stitching border(s), image orientation, zoom correction(s), contrast correction(s), and relative chrominance correction(s) (step 340).

These stitching parameters can now be transmitted from the server to the mobile device (step 350), enabling the mobile device to create a panorama from the captured images without the need for a fully functional stitcher (step 360). In this embodiment, the mobile device extracts EXchangeable Image File-format (“EXIF”) metadata from one or more of the captured images and associates the EXIF metadata with the panorama. It is contemplated that stitching includes creating a new panorama from the captured images, or simply modifying the captured images, e.g., by judicious cropping, so that the modified images can be easily assembled into a contiguous scene like a jigsaw puzzle.

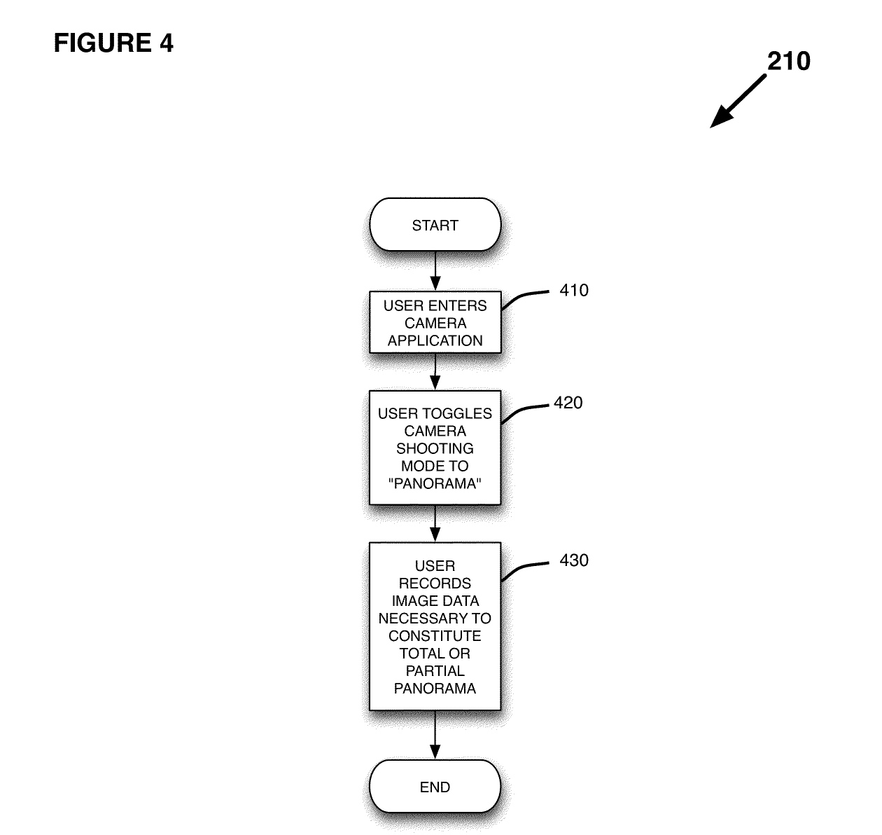

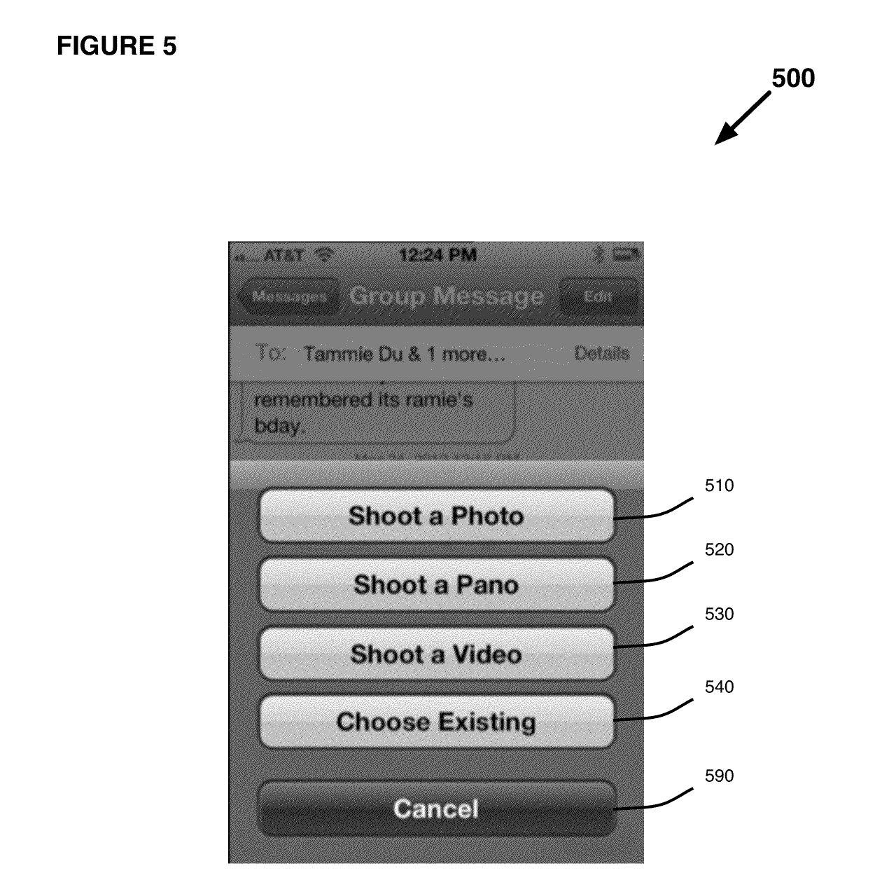

In FIGS. 4 and 5, an exemplary flow diagram 210 and screen shot 500, respectively, detailing the capture of images in panorama mode by the mobile device, a user can initiate a capture of images by selecting icon 520 (steps 410, 420). Once panorama capture mode has been selected, the mobile device is capable of recording images needed to constitute a total or partial panorama (step 430).

Referring back to the flow diagram of FIG. 1, in step 125, the user can preview one or more panoramas using the mobile device. When the user locates the desired panorama(s), the panorama(s) can be attached to the MMS message and delivered to one or more recipients (steps 130, 135). Alternatively, if the user changes her/his mind about attaching the panorama(s), the panorama(s) can be discarded.

In accordance with the various embodiments of the present invention, downsizing one or more images is intended to reduce or compress the respective file size(s) for efficient storage and transmission, e.g., over a wireless network such as a cellular service. Downsizing of image(s) captured by the mobile device can be accomplished using the exemplary techniques described below.

In some embodiments, downsizing of the image file size includes downsampling the captured image(s) and generating corresponding lower resolution image(s). Downsampling of captured image(s) can be implemented using mathematical tools such interpolation and averaging. Image file compression can also be accomplished using more sophisticated mathematical models such as Fourier transformation or Huffman coding.

Captured image(s) can also be downsized using alternate file formats. Hence instead of using a raster-scanned (also known as bit-mapped) image file format such as JPEG, TIFF, PNG, GIF, or BMP format, a more memory-efficient vector file format can be used, including CGM, Gerber format (RS-274X) and SVG format.

Downsizing of the captured image(s) by the mobile device can also be accomplished by substantially reducing the chromatic data of the captured image(s). Such solutions can range from simply converting a color image into a corresponding black and white image to biasing the contrast data (e.g., luminance) over the chromatic data for each pixel.

Another method for downsizing the captured image(s) include substantially masking or redacting a central portion of the captured image(s) that is not essential for generating stitching parameters for the captured image(s). This method is feasible because stitching generally involves manipulating (e.g., cropping) and/or joining the peripheral portions of two or more images.

It should be appreciated that downsizing of image(s) captured by the mobile device can be accomplished using one or more of file reducing techniques, including the method described above, alone or in combination.

Many modifications and additions are also possible. For example, instead of downsizing every captured image and transmitting all the downsized images to the server, it is also possible, to downsize some of the captured images and transmit a combination of downsized image(s) and captured image(s) to the server.

In sum, the present invention provides systems and methods for stitching and sharing panoramas. The advantages of such systems and methods include efficient use of broadband bandwidth and the preservation of EXIF metadata for the panorama, enabling, for example, the recipient to be able to geographically associate and place the panorama at an appropriate location on a map.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for efficiently stitching a plurality of images into a panorama, useful in association with a mobile device, the method comprising:
downsizing at least one image of a plurality of captured images, wherein the at least one downsized image is generated by a mobile device;
transmitting the at least one downsized image to a server, wherein the server includes a panoramic stitcher;
receiving stitching parameters from the server; and
stitching the plurality of captured images into a panorama utilizing the stitching parameters from the server.

2. The method of claim 1 wherein the downsizing of the at least one image includes substantially downsampling the at least one image and generating a lower-resolution downsized image.

3. The method of claim 1 wherein the downsizing of the at least one image includes generating at least one corresponding vectorized image.

4. The method of claim 1 wherein the downsizing of the at least one image includes substantially reducing chromatic data of the at least one image.

5. The method of claim 1 wherein the downsizing of the at least one image includes substantially masking a central portion of the at least one image.

6. The method of claim 1 wherein the stitching parameters includes at least one of order of images, coordinates of stitching borders, image orientation, zoom corrections, contrast corrections and relative chrominance corrections.

7. The method of claim 1 further comprising sending the panorama and associated EXIF metadata to a recipient.

8. The method of claim 7 wherein the EXIF metadata is representative of at least two of the plurality of captured images.

9. The method of claim 1 wherein stitching the plurality of captured images into a panorama includes manipulating peripheral portions of the plurality of captured images.

10. The method of claim 1 wherein stitching the plurality of captured images into a panorama includes generating a new image which includes portions of each of the plurality of captured images.

11. A computerized mobile device configured to efficiently stitching a plurality of images into a panorama, useful in association with a server, the mobile device comprising:
an image reducer configured to downsize at least one image of a plurality of captured images, wherein the at least one downsized image is generated by a mobile device;
a transmitter configured to send the at least one downsized image to a server, wherein the server includes a panoramic stitcher;
a receiver configured to receive stitching parameters from the server, wherein the stitching parameters associated with (correspond) to the plurality of images; and
a panoramic stitcher configured to stitch the plurality of captured images into a panorama utilizing the stitching parameters from the server.

12. The mobile device of claim 11 wherein the downsizing of the at least one image includes substantially downsampling the at least one image and generating a lower-resolution downsized image.

13. The mobile device of claim 11 wherein the downsizing of the at least one image includes generating at least one corresponding vectorized image.

14. The mobile device of claim 11 wherein the downsizing of the at least one image includes substantially reducing chromatic data of the at least one image.

15. The mobile device of claim 11 wherein the downsizing of the at least one image includes substantially masking a central portion of the at least one image.

16. The mobile device of claim 11 wherein the stitching parameters includes at least one of order of images, coordinates of stitching borders, image orientation, zoom corrections, contrast corrections and relative chrominance corrections.

17. The mobile device of claim 11 further comprising sending the panorama and associated EXIF metadata to a recipient.

18. The mobile device of claim 17 wherein the EXIF metadata is representative of at least two of the plurality of captured images.

19. The mobile device of claim 11 wherein stitching the plurality of captured images into a panorama includes manipulating peripheral portions of the plurality of captured images.

20. The mobile device of claim 11 wherein stitching the plurality of captured images into a panorama includes generating a new image which includes portions of each of the plurality of captured images.

21. A computerized method for efficiently stitching a plurality of images into a panorama, useful in association with a mobile device, the method comprising:
receiving a plurality of images including at least one downsized image from a mobile device, wherein the at least one downsized image is generated from at least one of a plurality of images;
generating stitching parameters for the plurality of images; and
sending stitching parameters to the mobile device, wherein the stitching parameters are intended to be utilized by the mobile device for stitching the plurality of images.

22. The method of claim 21 wherein the at least one downsized image is an at least one downsampled image.

23. The method of claim 21 wherein the at least one downsized image is an at least one vectorized image.

24. The method of claim 21 wherein the at least one downsized image is an at least one substantially reduced-chroma image.

25. The method of claim 21 wherein the at least one downsized image is an at least one substantially masked image.

26. The method of claim 21 wherein the stitching parameters includes at least one of order of images, coordinates of stitching borders, image orientation, zoom corrections, contrast corrections and relative chrominance corrections.

27. A computerized server configured to efficiently stitch a plurality of images into a panorama, useful in association with a mobile device, the server comprising:
a receiver configured to receive a plurality of images including at least one downsized image from a mobile device, wherein the at least one downsized image is generated from at least one of a plurality of images;
a panoramic stitcher configured to generate stitching parameters for the plurality of images; and
a transmitter configured to send stitching parameters to the mobile device, wherein the stitching parameters are intended to be utilized by the mobile device for stitching the plurality of images.

28. The server of claim 27 wherein the at least one downsized image is an at least one downsampled image.

29. The server of claim 27 wherein the at least one downsized image is an at least one vectorized image.

30. The server of claim 27 wherein the at least one downsized image is an at least one substantially reduced-chroma image.

31. The server of claim 27 wherein the at least one downsized image is an at least one substantially masked image.

32. The server of claim 27 wherein the stitching parameters includes at least one of order of images, coordinates of stitching borders, image orientation, zoom corrections, contrast corrections and relative chrominance corrections.
